(19) United States
(12) Patent Application Publication
(10) Pub. No.: US 2009/0006553 A1
(43) Pub. Date: Jan. 1, 2009

(54) Remote Collaboration Tool For Rich Media Environments

(76) Inventor: Suman Grandhi, Irvine, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/131,856

(22) Filed: Jun. 2, 2008

Related U.S. Application Data
(60) Provisional application No. 60/932,676, filed on Jun. 1, 2007.

(51) Int. Cl. G06F 15/16; G06F 17/30

(52) U.S. Cl. 709/205; 707/8; 707/E17.007

(57) ABSTRACT

A remote collaboration tool, system and method are presented. The remote collaboration tool can be hosted by a collaboration computer for enabling collaborative communication of rich media files between a server connected with a rich media data source and a plurality of client computers over a network. The remote collaboration tool includes a locking mechanism for locking all subsequent versions of a rich media file that has been requested by one of the plurality of client computers. The remote collaboration tool further includes a synchronization engine for synchronizing the requested rich media file with all subsequent versions of the rich media file to generate a synchronized rich media file for storage in the rich media data source.

### CROSS REFERENCE TO RELATED APPLICATIONS

This application claims the benefit under 35 U.S.C. Section 119(e) of a U.S. provisional application Ser. No. 60/932,676, entitled “Remote Collaboration Tool For Rich Media Environments,” filed Jun. 1, 2007 (Attorney Docket No. 35084-501-PRO), which is incorporated by reference herein.

### BACKGROUND

This disclosure relates generally to computer-implemented collaboration tools, and more particularly to a collaboration tool and technique for rich media environments.

Numerous source control systems currently exist for non-rich media (i.e. text-based) environments. Rich media environments deal largely with binary data rather than text-based data. Current source control systems have been designed largely to deal with coordinating changes made by multiple users concurrently on a single file. This problem is generally dealt with merging changes, merging versions, etc.

In a rich media environment, several issues make traditional source control systems unusable. For instance, there is no easy way to merge audio/video binary data, and such technique is impossible unless a user has internal application knowledge to merge two rich media files in a sensible manner. In another instance, changes made to rich media sources cannot be simply synchronized to the server as in text-based source control systems. As data sets in rich media environments are large, additional algorithms are needed to ensure that data transmission is minimized. Further, for long latency, high bandwidth links, data transmissions have to be wide area network (WAN) accelerated as well.

Other technologies such as wide area file services (WAFS) or central network-based file access like network attached storage (NAS) etc., suffer from similar issues. As rich media files tend to be very large, any technology that relies on accessing data over remote network links yields unacceptable performance. Hence, most rich media environments rely on local copies of media. Ensuring that multiple users, each having an independent copy of the same file, are not making changes in parallel is also a central challenge in media rich environments.

### SUMMARY

In general, this document discusses a system and method for a collaboration tool and technique for rich media environments. In accordance with one aspect, a remote collaboration tool is presented. The remote collaboration tool is hosted by a collaboration computer for enabling collaborative communication of rich media files between a server connected with a rich media data source and a plurality of client computers over a network. The remote collaboration tool includes a locking mechanism for locking all subsequent versions of a rich media file that has been requested by one of the plurality of client computers. The remote collaboration tool further includes a synchronization engine for synchronizing the requested rich media file with all subsequent versions of the rich media file to generate a synchronized rich media file for storage in the rich media data source.

In accordance with another aspect, a collaborative computing system includes a server connected with a rich media data source and adapted to communicate rich media files over a network to a plurality of client computers, and a remote collaboration tool hosted by collaboration computer in communication with the plurality of client computers and the network.

In yet another aspect, a rich media collaborative computing method includes the steps of checking out a rich media file from a server to a first user associated with one of a plurality of client computers, applying a lock to the checked out rich media file for subsequent users, and for subsequent users that request the rich media file from the server, checking out read-only versions of the rich media file based on the lock. The collaboration tool, system and method presented herein provide an easy way to merge audio/video binary data, and to synchronize changes made to rich media sources with minimal resources.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a collaborative computing environment in which the system and method are suitably employed.

FIG. 2 is a flowchart of a process flow for a collaboration tool.

Like reference symbols in the various drawings indicate like elements.

### DETAILED DESCRIPTION

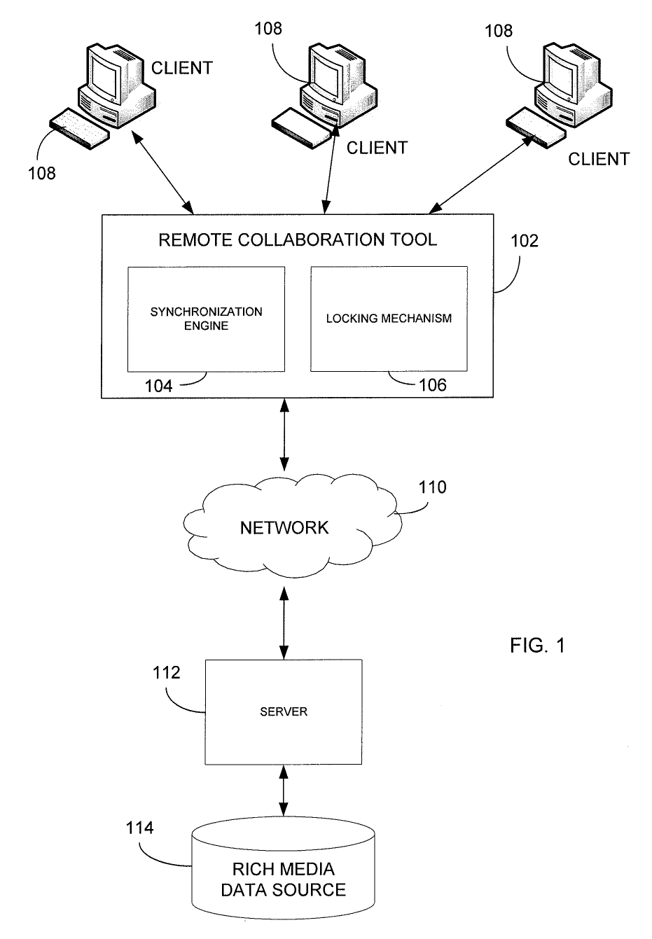

This document describes a remote collaboration tool for rich media environments. The remote collaboration tool is embodied in both a remote collaboration system and method, as well as various techniques for the execution thereof. As shown in FIG. 1, a remote collaboration tool 102 includes a synchronization engine 104 that is adapted to perform delta transmission, intelligent file detection (based on file name, modified time, size, full file checksums, file fingerprints, etc.), and TCP/IP acceleration. The remote collaboration tool further includes a locking mechanism 106 that enables file locks on end user systems (i.e. on client computers 108). The remote collaboration tool 102 enables collaborative communication of rich media among users of the client computers 108, and with a server 112 having a rich media data source 114 that communicates over a network 110, such as the Internet.

As an example, once a file or group of files are checked in, they are made read-only on that user's local systems. As other users check out copies of those files, their local copies are also made read only. Only when one of the users takes a write lock, can that user edit his local copy. If another user proceeds to take a write lock, while another user has a write lock, the second user is denied permissions to lock, with a warning that another user has locked that file. Once the write lock has been relinquished and the latest version of the file has been checked in, other users can take locks. However, a user must have the latest file version to take a write lock.

By way of another example, in a collaborative computing environment, all users initially have only read-only access privileges to their media files. Only one user can obtain a lock on a media file. The lock grants that user to be able to modify the media file. During the time the media file is locked by one user, no other user may be given a file lock to that same media file. After the media file is modified and then checked into the server, the lock is released. Only then can another user be given a lock on that media file. This enables a unique workflow not currently present for any rich media based remote collaborative environment.

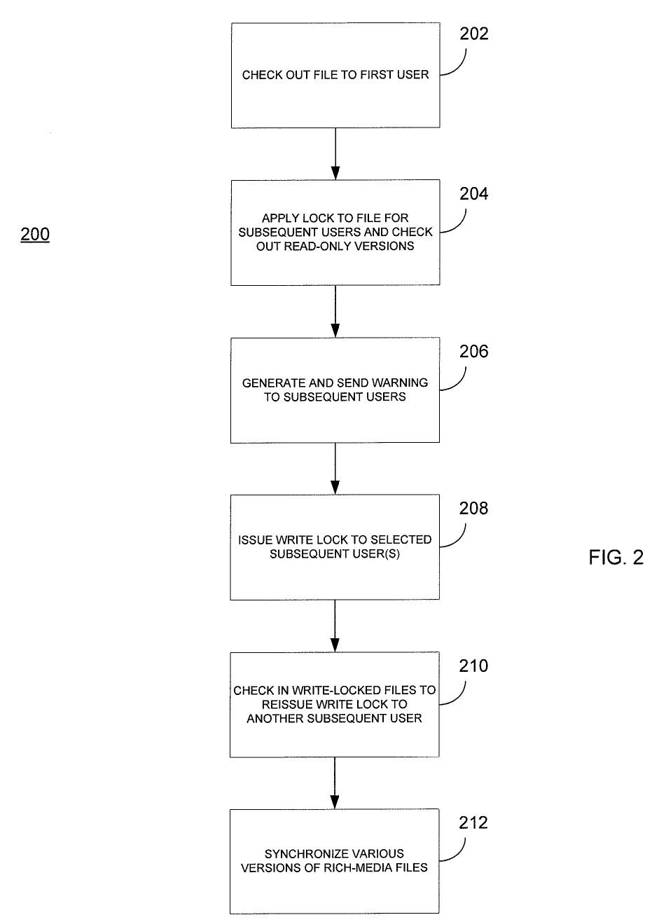

FIG. 2 is a flowchart of a method 200 for remote collaborative computing using a remote collaboration tool as described above. At 202, a file is checked out to a first user. The file is preferably a rich media file, i.e. containing rich media content such as images, video, audio or a combination thereof At 204, a lock is applied to the file to lock the file for subsequent users, and read-only versions are only allowed to be checked out for the term of the lock.

At 206, a warning is generated and sent to subsequent users who access the read-only versions of the file. At 208, a write lock is issued to selected subsequent user(s). At 210, write-locked files are checked in, and the write lock is reissued to another subsequent user. At 212, the various versions of the file are synchronized by the remote collaboration tool, including the original file, the read-only versions of the file, and the write-locked files. Accordingly, the remote collaboration tool controls remotely controls access and use of rich-media files and manages, on behalf of the rich media data source and server systems, the use and changes made to such rich-media files.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A collaborative computing system comprising:
a server connected with a rich media data source and adapted to communicate rich media files over a network to a plurality of client computers;
a remote collaboration tool hosted by collaboration computer in communication with the plurality of client computers and the network, the remote collaboration tool including a locking mechanism for locking all subsequent versions of a rich media file that has been requested by one of the plurality of client computers, and a synchronization engine for synchronizing the requested rich media file with all subsequent versions of the rich media file to generate a synchronized rich media file for storage in the rich media data source.

2. The collaborative computing system in accordance with claim 1, wherein the synchronization engine is further adapted to perform delta transmission, intelligent file detection, and TCP/IP acceleration of all requests from the plurality of client computers for the rich media file.

3. The collaborative computing system in accordance with claim 2, wherein the intelligent file detection is based on file name, modified time, size, full file checksums, and/or file fingerprints.

4. The collaborative computing system in accordance with claim 1, wherein the locking mechanism is adapted to issue a write lock to all other client computers than the one of the plurality of client computers that requested the rich media file, and for all subsequent versions of the rich media file.

5. A remote collaboration tool hosted by a collaboration computer for enabling collaborative communication of rich media files between a server connected with a rich media data source and a plurality of client computers over a network, the remote collaboration tool comprising:
a locking mechanism for locking all subsequent versions of a rich media file that has been requested by one of the plurality of client computers; and
a synchronization engine for synchronizing the requested rich media file with all subsequent versions of the rich media file to generate a synchronized rich media file for storage in the rich media data source.

6. The remote collaboration tool in accordance with claim 5, wherein the synchronization engine is further adapted to perform delta transmission, intelligent file detection, and TCP/IP acceleration of all requests from the plurality of client computers for the rich media file.

7. The remote collaboration tool in accordance with claim 6, wherein the intelligent file detection is based on file name, modified time, size, full file checksums, and/or file fingerprints.

8. The remote collaboration tool in accordance with claim 5, wherein the locking mechanism is adapted to issue a write lock to all other client computers than the one of the plurality of client computers that requested the rich media file, and for all subsequent versions of the rich media file.

9. The remote collaboration tool in accordance with claim 5, wherein the rich media file includes binary data representing rich media content.

10. The remote collaboration tool in accordance with claim 5, wherein the remote collaboration tool is distributed as a local application and resident on each of the plurality of client computers.

11. A rich media collaborative computing method comprising:
checking out a rich media file from a server to a first user associated with one of a plurality of client computers;
applying a lock to the checked out rich media file for subsequent users; and
for subsequent users that request the rich media file from the server, checking out read-only versions of the rich media file based on the lock.

12. The collaborative computing method in accordance with claim 11, further comprising issuing the lock to client computers associated with subsequent users of the rich media file to generate write-locked files.

13. The collaborative computing method in accordance with claim 12, further comprising checking in one write-locked file to reissue the associated lock to another subsequent user of the rich media file.

14. The collaborative computing method in accordance with claim 13, further comprising synchronizing all versions of the rich media file in a remote collaboration computer to generate a synchronized rich media file.

15. The collaborative computing method in accordance with claim 14, further comprising transmitting the synchronized rich media file to the server.
